(19) United States
(12) Patent Application Publication
(10) Pub. No.: US 2006/0101967 A1
(43) Pub. Date: May 18, 2006

(54) Greater capacity cutting saw

(76) Inventors: Jaime E. Garcia, Jackson, TN (US); Craig A. Carroll, Milan, TN (US)

Correspondence Address: THE BLACK & DECKER CORPORATION, 701 EAST JOPPA ROAD, TW199, TOWSON, MD, 21286, US

(21) Appl. No.: 10/801,273

(22) Filed: Mar. 16, 2004

Related U.S. Application Data
(63) Continuation-in-part of application No. 10/717,987, filed on Nov. 19, 2003, now abandoned.
(60) Provisional application No. 60/427,647, filed on Nov. 19, 2002.

(51) Int. Cl. B23D 45/04

(52) U.S. Cl. 83/473; 83/471.3; 83/490

(57) ABSTRACT

The present invention is directed to an apparatus for providing maximized cutting capacity for the diameter of blade selected. A saw, in accordance with an aspect of the present invention, includes a base, a workpiece positioning fence coupled substantially perpendicular to the base for position against a side of the fence includes a cutting assembly is pivotally mounted to the saw to achieve a full-cut position. Preferably, a motor included in the cutting assembly is orientated generally perpendicularly to the arbor for rotating the circular saw blade. When disposed in a full-cut position an included circular saw blade's periphery is disposed substantially equal to the intersection of the base support surface and workpiece positioning side of the workpiece positioning fence.

### CROSS REFERENCE

The present application is a Continuation-in-Part and claims priority under 35 U.S.C. §120 to U.S. patent application Ser. No. 10/717,987 entitled: Greater Cutting Capacity Saw, filed on Nov. 19, 2003, which in-turn claims priority under 35 U.S.C. §119(e) to U.S. Provisional Patent Ser. No. 60/427,647, entitled: Greater Cutting Capacity Saw, filed on Nov. 19, 2002, both of which are hereby incorporated by reference in their entirety.

### FIELD OF THE INVENTION

The present invention generally relates to the field of power tools and more particularly to a saw having a greater cutting capacity.

### BACKGROUND OF THE INVENTION

Saws and in particular chop-saws, miter saws (both beveling and non-beveling), and the like are often configured to perform a chopping action. These devices are often utilized to cut large dimensioned workpieces such as large trim pieces, moldings and the like. For instance, in order to cut a piece of crown molding the workpiece may have to be angled up against a support fence while cutting occurs. This cutting action is problematic because the workpiece requires the saw have a large capacity in both a vertical direction and a horizontal direction (with respect to a fence). A saw's overall capacity may be limited, over a user's desire, especially when the saw is utilized to perform a beveled cut, a miter cut, or a combination cut. Previous saws employing a chopping type action were of limited capacity. As a result, the saw's cutting capacity may be adversely limited by the saw's configuration including the motor, the guards, and the like. Thus, the effective cutting capacity of the saw is diminished.

Therefore, it would be desirable to provide a saw having a greater effective cutting capacity for accepting a large dimensioned workpiece.

### SUMMARY OF THE INVENTION

Accordingly, the present invention is directed generally to a saw having an enlarged effective cutting capacity.

In a first aspect of the present invention, a miter saw includes a base for at least partially supporting a workpiece thereon. A workpiece positioning fence is coupled substantially perpendicularly to the base to allow for workpiece positioning. A cutting assembly, including a motor orientated perpendicular to an arbor for rotating a circular saw blade and a gear assembly for transferring the rotational energy from the motor to the arbor, is pivotally mounted to the saw such that the assembly may clear the workpiece positioning fence when cutting a 45° (forty-five degree) miter.

In a further aspect of the present invention, a saw including a base, a workpiece positioning fence coupled substantially perpendicular to the base for position against a side of the fence includes a cutting assembly is pivotally mounted to the saw to achieve a full-cut position. When disposed in a full-cut position an included circular saw blade's periphery is disposed substantially equal to the intersection of the base support surface and workpiece positioning side of the workpiece positioning fence.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is perspective view illustrating a chop-type miter saw in accordance with an aspect of the present invention;

FIG. 2 is a side view of a miter saw having a cutting assembly disposed generally in a full-cut position;

FIG. 3 is a side view of miter saw configured with a cutting assembly disposed in a released position;

FIG. 4 is an alternate side view of a miter saw in accordance with an aspect of the present invention including a cutting assembly extending through a workpiece;

FIG. 5 is a front view of a miter saw in accordance with an aspect of the present invention; and

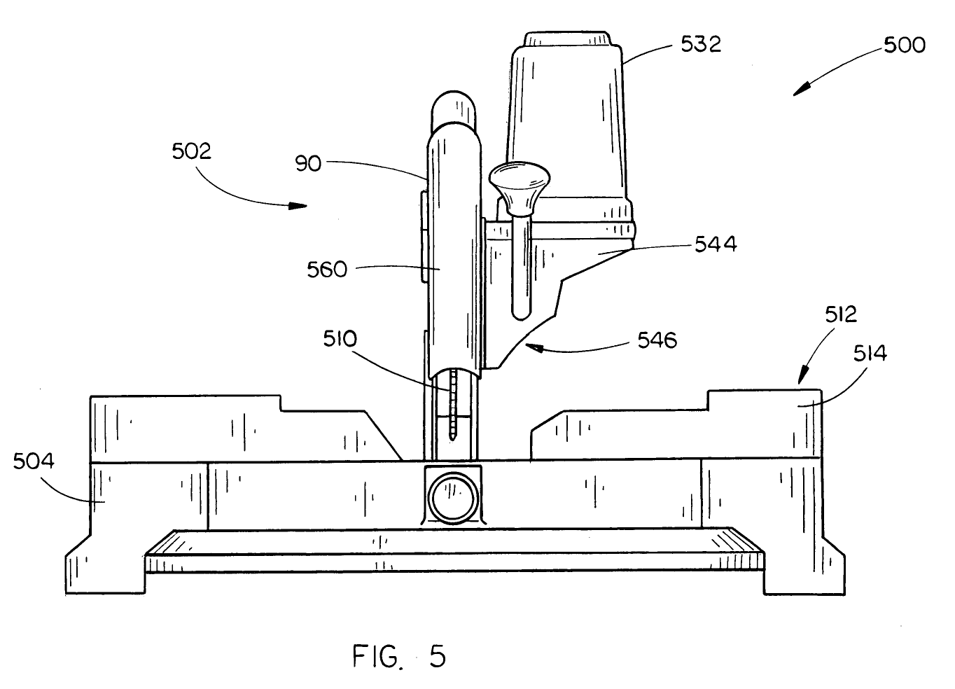

FIG. 6 is a partial cut-away view of gear assembly in accordance with a further aspect of the present invention.

### DETAILED DESCRIPTION OF THE INVENTION

Reference will now be made in detail to the presently preferred embodiments of the invention, examples of which are illustrated in the accompanying drawings. Those of skill in the art will appreciate that the apparatus of the present invention may be implemented with various saws such as a chop-saw, a chop-type miter saw, a sliding miter saw without departing from the spirit and scope of the present invention.

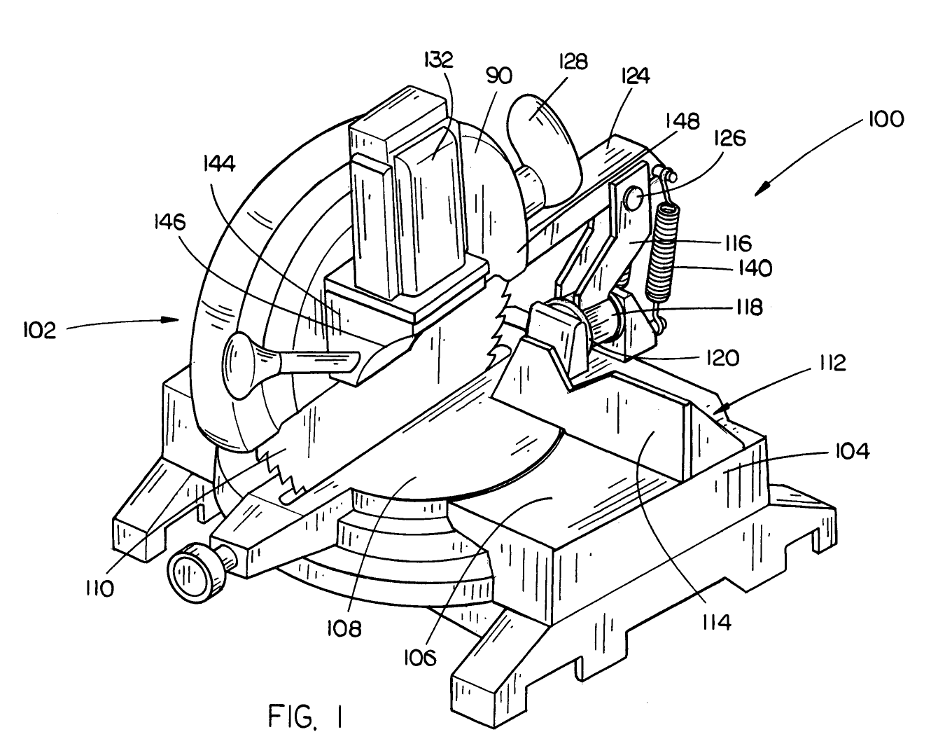

Referring to FIG. 1, a miter saw 100 in accordance with the present invention is disclosed. The miter saw 100 is a chop-type miter saw in which the cutting assembly 102 pivots to engage a workpiece. For example, a user operates the saw by depressing the cutting assembly 102 through the workpiece in an arcing motion. A base 104 is included to at least partially support a workpiece on a support surface 106. The miter saw 100 may include a turntable 108, or the like for adjusting the angular orientation of a saw blade 110 with respect to a workpiece positioning fence 112. For example, a user may rotate the turntable and cutting assembly 102 to a 45° position with respect to the positioning fence 112 to form a miter cut for a cabinet frame. In the foregoing example, the cutting assembly may be configured in order to prevent the assembly/motor from contacting the fence or a workpiece. Preferably, the fence 112 is substantially perpendicular to the support surface so a user may position crown molding or the like against the fence to achieve the desired cut. In the previous example, the user positions the workpiece on the support surface 106 and against a workpiece positioning side of the fence 114. Alternatively, a user may utilize a spacer such as a waste scrap of two by material (e.g., 2″×4″) to act as an intermediate between a workpiece and the fence such as to support a small workpiece, or the like.

In the current embodiment, a support 116 extends away from the base 104 for supporting the cutting assembly 102. The support 116 is coupled to the turntable 108 so a user may rotate the turntable and thereby rotating the cutting assembly. In further embodiments, a chop saw (non-miter, non-bevel) support may be attached or directly fixed to the base. Furthermore, a support may be configured to be implemented with a sliding miter saw such as when a rail mechanism (such as a cylindrical rail or rails) is included between the base/turntable and the support. In still further embodiments, a support may include a coupling for connecting a sliding mechanism on the end of the support 116 distal from the base. Preferably, the support 116 may be of sufficient length (between the base and a pivotal connection with a mounting arm 124) to allow for maximum workpiece capacity. For example, the support is configured with an assembly pivot point further from the base than the center of rotation of a saw blade when a mounting arm is parallel with the base so as to allow for a downward/rear arc though-out the chopping range. Alternatively, the pivotal connection of the cutting assembly 102 and the base is adjacent the base 104 in further implementations.

In the present embodiment, the support 116 is coupled via a bevel mechanism, such as a trunnion 118. Other beveling mechanisms, for beveling a circular saw blade 110 with respect to the support surface 106, may be implemented as desired.

With continued reference to FIG. 1, a mounting arm 124 is pivotally mounted to the support 116 to form a pivot point about which the cutting assembly 102 arcs or pivots. For example, a bolt 126 extends through an aperture included in the support 116 and the mounting arm to allow the cutting assembly to achieve a plurality of positions. In further examples, a pivot pin, or the like may be utilized for pivotally mounting the cutting assembly. In alternative embodiments, the cutting assembly 102 and the support may be coupled via a slide mechanism with a pivotal mounting for coupling a blade housing or the like to the slide mechanism. Alternatively, a support arm may be unitarily formed with a blade guard, such as an upper blade guard 90. In additional examples, a dust duct 128 is included for at least partially directing the dust and debris generated during operation into the duct. Moreover, a carrying handle may be mounted to the mounting arm to facilitate transport of the saw.

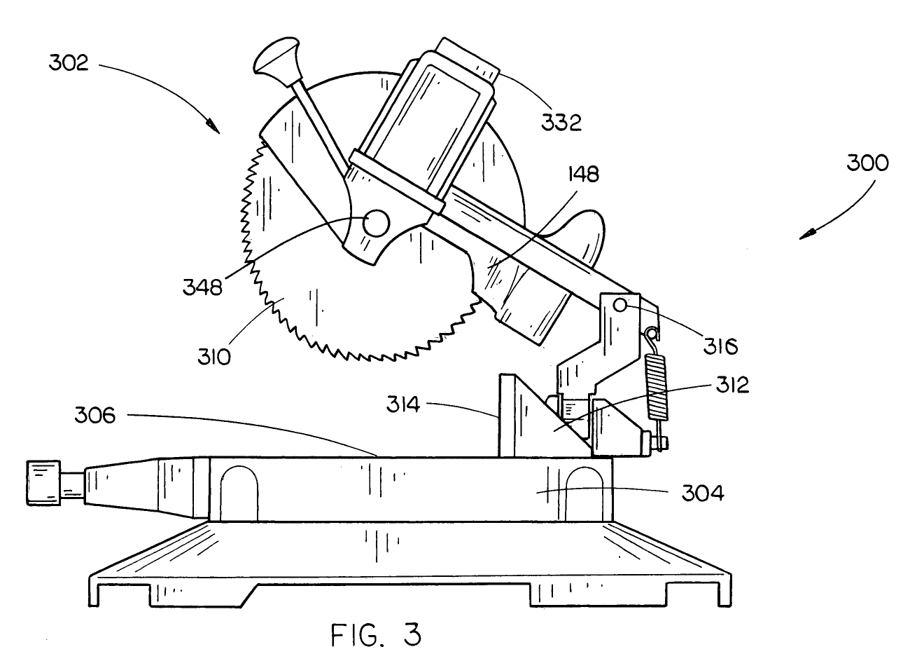

Preferably, the mounting arm 124 is biased in a released position (away from the base as may be generally seen in FIG. 3). Biasing the mounting arm 124 away from the base allows a user to easily position a workpiece without having to initially manipulate the cutting assembly such as by a user grasping a handle for directing the cutting assembly generally towards the base. Suitable handles include knob type handles, straight handles, D-shaped handles, and the like. Preferably, a switch for controlling the saw's electrical system is mounted to or adjacent to the handle. For example, a D-handle, mounted either perpendicular to the blade or parallel to the blade, including a bar or trigger switch (for controlling the saw's motor) may be included. In a preferred embodiment, an extension spring 140 is utilized to bias the cutting assembly 102 away from the base.

A motor for rotating a circular saw blade is included in the cutting assembly 102. The motor may be enclosed in a housing 132, or the like for protecting the motor from dust, debris, and the like. Preferably, the motor/motor housing 132 is orientated parallel to a plane substantially encompassing the saw blade 110, or substantially perpendicular to an arbor. Orientating the motor housing perpendicular to an arbor about which the saw blade rotates may promote a greater cutting capacity over that of a direct drive motor. For example, by orientating the motor parallel with the saw blade, the cutting assembly may be able to cut a larger workpiece, such as when mitering at 45° and/or beveling without contacting a fence/the workpiece. In another example, if an in-line motor is utilized, the motor may extend further towards a cutting zone (e.g., the area where the saw blade is cutting) of the saw generally located in quadrant adjacent the fence/support surface interface. In further embodiments, a circular saw blade may be driven by a belt drive or other transmission system so that the motor may be orientated away from the cutting blade.

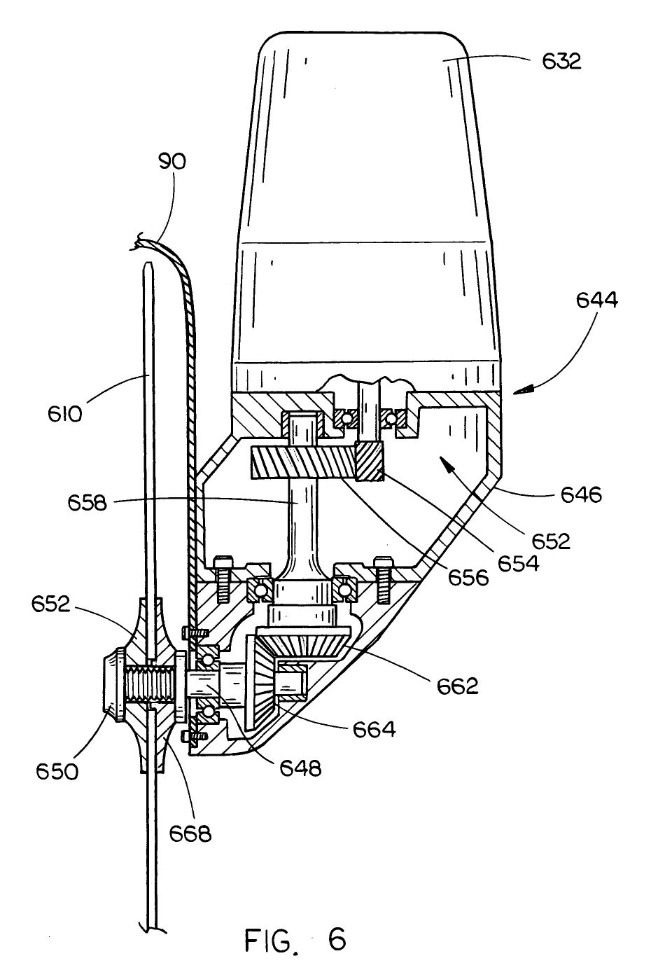

Referring to FIG. 6, in a preferred embodiment, a gear box 644 extends from a side of the arbor 648. For example, a saw gear assembly 652 (transmission) may transmit the rotational energy from the motor through a helical gear set (including a gear included on the motor drive shaft 654 and an intermeshing gear 656 included on a first end of a jack shaft 658) and a 90° (ninety degree) gear set (including a bevel gear 622 on a second end of the jack shaft 658 and a bevel gear 664 included on the arbor shaft 648) coupled to the arbor 648 for mounting the saw blade 610 thereto (such as secured via a bolt 650/flange. Furthermore, the jack shaft 658 may be configured to extend between the helical gear set and the 90° (ninety degree) gear set to allow for adjustment (such as to allow for manufacturing variance), minimize stress on various gear components, and the like. Configuring the gear assembly 652 with an intermediate jack shaft may allow for maximized cutting capacity without the gear box/motor housing contacting a workpiece positioning fence when performing bevel/miter cuts and in particular bevel/miter cuts at 45° (forty-five degrees) Preferably, the gear box 644 is tapered 646 generally in the direction of the base (narrows towards the arbor) such that the gear box does not interfere with mitering operations (such as by contacting the fence when cutting a 45° and/or bevel miter), or by contacting the workpiece, such as when a trim piece is angled against the workpiece positioning fence 112.

An upper blade guard 90 may extend generally about the portion of the saw blade 122 away from the base 104. For example, the saw blade guard 90 may generally cover a third of the saw blade away from the base. Moreover, the upper guard 90 may include an extension 148, or guard for covering a portion of the blade teeth adjacent a cutting zone. The extension may be formed unitary with the upper guard, or formed as a separate guard coupled to the upper guard. An extension 148 including on the upper blade guard may allow for a larger vertical cutting capacity without exposing additional teeth. Preferably, an extension is configured to maximize the vertical capacity established by the blade and the pivoting action of the cutting assembly as the cutting assembly pivots about the cutting assembly pivot point included on the support 116.

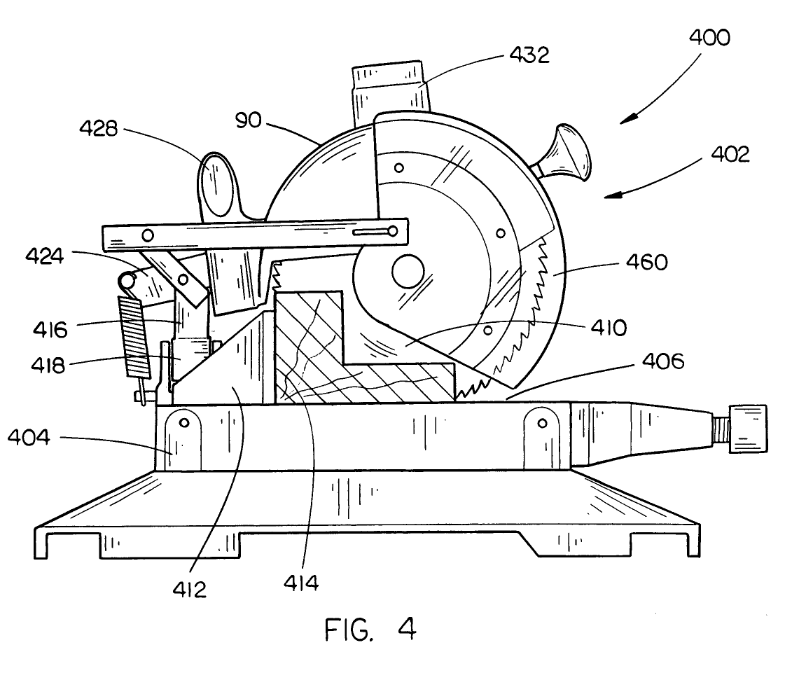

In additional examples, a lower blade guard 460 (as may be seen in FIG. 4), or a pivoting/rotating blade guard is included to adjustably cover the saw blade. A lower blade guard 460 may act to minimize blade exposure during cutting operations. The lower blade guard may include linkages for rotating the guard as the cutting assembly is directed toward a workpiece.

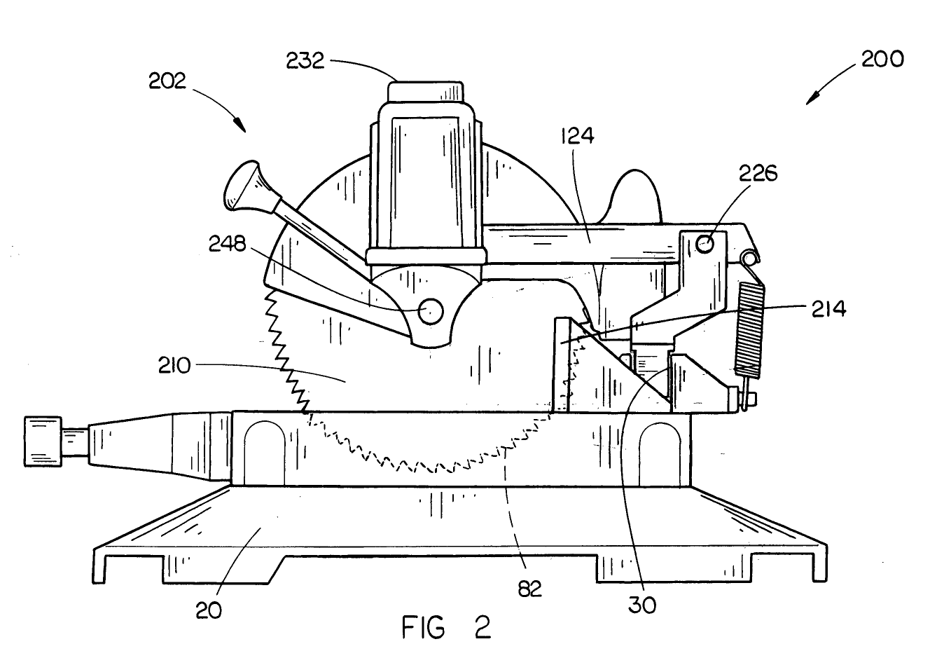

Referring now to FIGS. 2, 3, and 4, in preferred embodiments, a saw 200 including a cutting assembly 102 is arranged to maximize cutting capacity. A saw of the present invention may allow for cutting capacity optimization in both a vertical direction (normal to a support surface 106 of a base, or parallel the positioning fence) and a lateral direction (generally parallel to the support surface of the base 206) over previous devices. The cutting assembly 202 may be configured to achieve a plurality of positions. For example, the cutting assembly may be capable of pivoting between a released position where the assembly 302 and saw blade are remote from the base 304 and a full-cut positions such as when the cutting assembly is closest to the base (e.g., the saw blade has reached its maximum penetration through the base support surface). As may be generally seen in FIG. 3, a full-cut position (as may be generally seen in FIG. 2) may dispose the periphery of the saw blade substantially equal to the interface of a workpiece position side of the fence 214 and the workpiece support surface included on the base 204. Disposing the outer surface (such as the tooth of the blade) substantially equal to the fence/support surface may allow the saw to have maximized lateral cutting capacity (away from the fence in a horizontal direction when the base is disposed on a support surface). Those of skill in the art will appreciate that it may be desirable for the blade tooth to extend slightly beyond the interface of the fence and the support surface so as to maximize lateral capacity without failing to fully cut the workpiece. For example, configuring the saw to extend the blade slightly beyond the workpiece positioning side of the fence/workpiece support surface interface may account for a saw blade having a radius nominally less than the radius for which the saw was configured, such as to account for manufacturing tolerances in saw blades, account for miter cuts, or the like. Preferably, the saw is configured so that the user is not forced to reposition the workpiece, utilize a hand saw, or the like to finish off the cut. In a full cut position, it is desirable that the radius of the saw blade extend substantially equal to the workpiece positioning side of the fence and the workpiece support interface. In other words, the arc of the cutting assembly 302 pivoting about the support should generally dispose the center of rotation of the saw blade (the arbor) at the radius of the saw blade from the fence/support interface. Thus, for a 12″ (twelve inch) blade, the center of the arbor 348 should be substantially at 6″ (six inches) from the fence/workpiece support interface when disposed in a full-cut position.

Preferably, the saw blade extends below the support surface 206, in a full-cut position such that a plane encompassing the support surface forms a chord through the saw blade in the range of greater than 8¼″ (eight and a quarter inches) for a 12″ (twelve inch) blade. This capacity is advantageous because a user is capable of cutting larger dimension lumber such as a 2″×10″ board (having an actual dimension of 1½″ by 9¼″ (one and a half inches by nine and a quarter inches)). More preferably, the cutting assembly is disposed in a full-cut position so that the support surface forms a chord through the saw blade of approximately 9¼″ (nine and a quarter inches) for a 12″ (twelve inches) blade thereby insuring a full cut through a 2″×10″ board (having an actual dimension of 1½″ by 9¼″). Those of skill in the art will appreciate that the capacity of 9¼″ (nine and a quarter inches) may be achieved without substantially sacrificing vertical capacity adjacent the arbor. For example, a saw configured generally in accordance with the foregoing may be capable of obtaining a lateral cutting capacity of greater than 75% (seventy-five percent) of the saw's diameter. More preferably, a saw may achieve approximately a 77% (seventy-seven percent) lateral cutting capacity as compared to the saw blade diameter. The foregoing being preferable as user may maximize capacity without having to purchase a more complex, or expensive saw. For instance, the arbor/arbor flange are disposed for at least a vertical capacity of 1½″ (one and a half inches) between the support surface and an arbor flange/motor housing.

Referring to FIG. 2, in a further aspect of the present invention, a saw 200 is configured so as to maximize the saw's effective cutting capability

It is believed that the apparatus of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A miter saw, comprising:
a base having a support surface for at least partially supporting a workpiece;
a workpiece positioning fence coupled to the base, said positioning fence being orientated substantially perpendicular to the support surface; and
a cutting assembly pivotally mounted on the miter saw to achieve a plurality of positions, said cutting assembly including:
a motor orientated substantially perpendicular to an arbor for rotating a circular saw blade; and
a gear assembly configured and arranged to transfer the rotational energy of the motor to the arbor,
wherein the gear assembly and motor are configured so as to not contact the workpiece position fence when the cutting assembly is disposed at the cutting assembly's closest position to the base when mitering at least a 45° (forty-five degree) from a plane substantially perpendicular to the workpiece positioning fence.

2. The miter saw of claim 1, wherein the gear assembly includes a helical gear set coupled to the motor and a bevel gear set between the helical gear set and the arbor.

3. The miter saw of claim 1, wherein the gear assembly includes a helical gear set coupled to the motor and a jack shaft extending between the helical gear set and a bevel gear set coupled to the arbor.

4. The miter saw of claim 1, further comprising a gear box for enclosing the gear assembly, said gear box being tapered in the direction of the base.

5. The miter saw of claim 1, further comprising a trunnion disposed between the cutting assembly and the base, said trunnion being constructed so as to permit the cutting assembly to bevel with respect to the base.

6. The miter saw of claim 1, further comprising a turntable pivotally mounted to the base, said turntable being constructed so as to rotate the cutting assembly with respect to the workpiece positioning fence.

7. The miter saw of claim 1, wherein the miter saw is at least one of a chop-type miter saw and a sliding miter saw.

8. A saw, comprising:
a base having a support surface for at least partially supporting a workpiece;
a workpiece positioning fence coupled to the base, said positioning fence being orientated substantially perpendicular to the support surface for positioning a workpiece on a side of the fence; and
a cutting assembly pivotally mounted on the saw to achieve a full-cut position, said cutting assembly including a motor configured to rotate a circular saw blade having a radius,
wherein the periphery of the saw blade is substantially equal to the interface between the support surface and the positioning fence, on the workpiece positioning side, when the cutting assembly is disposed in a full-cut position.

9. The saw of claim 8, wherein the intersections of the saw blade and a plane extending through the support surface, when the cutting assembly is in the full-cut position, is of a length greater than 75% (seventy-five percent) of the diameter of the saw blade.

10. The saw of claim 8, wherein the intersections of the saw blade and a plane extending through the support surface, when the cutting assembly is in the full-cut position, is of a length of approximately 77% (seventy-seven percent) of the diameter of the saw blade.

11. The saw of claim 8, further comprising a turntable pivotally mounted to the base, said turntable being constructed so as to rotate the cutting assembly with respect to the workpiece positioning fence.

12. The saw of claim 8, further comprising a trunnion disposed between the cutting assembly and the base, said trunnion being constructed so as to permit the cutting assembly to bevel with respect to the base.

13. The saw of claim 8, wherein the saw is at least one of a chop saw, a miter saw, and a beveling miter saw.

14. The saw of claim 8, wherein the cutting assembly includes gear assembly having a helical gear set coupled to the motor and a bevel gear set between the helical gear set and an arbor for rotating the circular saw blade.

15. The saw of claim 8, wherein the motor is orientated substantially parallel to a plane encompassing the circular saw blade.

16. The saw of claim 15, further comprising a gear box coupling the motor and the saw blade, wherein the gear box is tapered in the direction of the base.

17. A saw, comprising:
a base having a support surface for at least partially supporting a workpiece;
a workpiece positioning fence coupled to the base, said positioning fence being orientated substantially perpendicular to the support surface; and
a cutting assembly pivotally mounted on the saw to achieve a plurality of positions, said cutting assembly including:
a motor orientated substantially perpendicular to an arbor for rotating a circular saw blade; and
a jack shaft having a first end with a helical gear and a second end having a bevel gear, said jack shaft being configured to transfer the rotational energy from the motor to the arbor,
wherein the arbor includes a bevel gear for mechanically coupling with the bevel gear included on the jack shaft.

18. The saw of claim 17, further comprising a turntable coupled to the base, said turntable being configured to adjust the angular orientation of the saw blade with respect to a positioning fence.

19. The saw of claim 17, further comprising a trunnion disposed between the support and the saw base for beveling the saw blade with respect to the support surface.

20. The saw of claim 17, wherein the cutting assembly pivot point is further away from the base than the center of rotation of the saw blade when the mounting arm is parallel to the base.

21. The saw of claim 17, wherein the saw is at least one of a chop saw, a chop-type miter saw, a sliding miter saw, and a beveling miter saw.

22. The saw of claim 17, further comprising a gear box coupling the motor and the saw blade, wherein the gear box is tapered in the direction of the base.

23. The saw of claim 22, further comprising a flange for securing the circular saw blade to the arbor, wherein the gear box terminates adjacent the flange.

24. A miter saw, comprising:
a base having a support surface for at least partially supporting a workpiece;
a workpiece positioning fence coupled to the base, said positioning fence being orientated substantially perpendicular to the support surface;
a turntable pivotally mounted to the base, said turntable being constructed so as to rotate with respect to the workpiece positioning fence; and
a cutting assembly pivotally mounted to the turntable so as to achieve a plurality of positions, said cutting assembly including:
a motor orientated substantially perpendicular to an arbor for rotating a circular saw blade; and
a gear assembly configured and arranged to transfer the rotational energy of the motor to the arbor,
wherein the gear assembly and motor are configured so as to not contact the workpiece position fence when the cutting assembly is disposed at the cutting assembly's closest position to the base when mitering at 45° (forty-five degrees) from a plane substantially perpendicular to the workpiece positioning fence.

25. The miter saw of claim 24, further comprising a trunnion disposed between the cutting assembly and the turntable, said trunnion being constructed so as to permit the cutting assembly to bevel with respect to the base.

26. The miter saw of claim 24, wherein the periphery of the saw blade is substantially equal to the interface between the support surface and the positioning fence, on the workpiece positioning side, when the cutting assembly is disposed in a full-cut position.

27. The miter saw of claim 24, wherein the gear assembly includes a helical gear set coupled to the motor and a bevel gear set between the helical gear set and the arbor.

28. The miter saw of claim 24, wherein the gear assembly includes a helical gear set coupled to the motor and a jack shaft extending between the helical gear set and a bevel gear set coupled to the arbor.

29. The miter saw of claim 24, further comprising a gear box coupling the motor and the circular saw blade, wherein the gear box is tapered in the direction of the base.

30. The miter saw of claim 24, wherein the cutting assembly pivot point is further away from the base than the center of rotation of the circular saw blade when the mounting arm is parallel to the base.

33. A miter saw, comprising:
a base having a support surface for at least partially supporting a workpiece;
a workpiece positioning fence coupled to the base, said positioning fence being orientated substantially perpendicular to the support surface for positioning a workpiece on a side of the fence; and
means for cutting a workpiece, said cutting means being configured to obtain a full-cut position wherein the cutting means is approximately equal to the interface between the support surface and the positioning fence.

34. The miter saw of claim 33, wherein the cutting means configured so as to not contact the workpiece position fence when mitering at 45° (forty-five degrees) from a plane substantially perpendicular to the workpiece positioning fence.

35. The miter saw of claim 33, wherein the cutting means is additionally configured to bevel with respect to the base.
